(19) United States
(12) Patent Application Publication
(10) Pub. No.: US 2013/0018683 A1
(43) Pub. Date: Jan. 17, 2013

(54) SYSTEM AND DECISION MODEL FOR OPTIMIZING PRODUCT DEVELOPMENT PORTFOLIOS AND TECHNOLOGY PORTFOLIOS FOR BUILDING BRAND EQUITY

(71) Applicant: Steven M. Cristol, Seattle, WA (US)

(72) Inventor: Steven M. Cristol, Seattle, WA (US)

(21) Appl. No.: 13/623,032

(22) Filed: Sep. 19, 2012

Related U.S. Application Data
(63) Continuation-in-part of application No. 12/400,689, filed on Mar. 9, 2009.
Application No. 12/400,689 is a continuation-in-part of application No. 11/696,145, filed on Apr. 3, 2007.
Application No. 11/696,145 is a continuation-in-part of application No. 11/058,107, filed on Feb. 14, 2005, now Pat. No. 7,711,596.
(60) Provisional application No. 61/536,503, filed on Sep. 19, 2011.
(60) Provisional application No. 61/038,006, filed on Mar. 19, 2008.
(60) Provisional application No. 60/789,018, filed on Apr. 4, 2006.
(60) Provisional application No. 60/585,171, filed on Jul. 2, 2004.
(60) Provisional application No. 60/544,781, filed on Feb. 14, 2004.

(51) Int. Cl. G06Q 10/00

(52) U.S. Cl. 705/7.12

(57) ABSTRACT

A technology platform, software, business system and decision model to build brand equity or improve business performance through more effective product/technology portfolio management and better alignment of product and technology strategy with brand strategy

### PRIORITY CLAIM

This application claims the benefit of Provisional Patent Application No. 61/536,503 filed on Sep. 19, 2011 which claims priority to and incorporates by reference in its entirety U.S. patent application Ser. No. 12/400,689 filed Mar. 9, 2009 that in turn claims priority to and incorporates by reference in its entirety U.S. Provisional Patent Application Ser. No. 61/038,006 filed Mar. 19, 2008.

This application is a continuation-in-part and incorporates by reference in its entirety U.S. patent application Ser. No. 11/696,145 filed Apr. 3, 2007, that in turn claims priority to and incorporates by reference in its entirety U.S. Provisional Patent Application Ser. No. 60/789,018 filed Apr. 4, 2006.

This application is a continuation-in-part and incorporates by reference in its entirety U.S. Pat. No. 7,711,596 issued May 4, 2010, that in turn claims priority to and incorporates by reference in their entirety U.S. Provisional Patent Application Ser. No. 60/585,171 filed Jul. 2, 2004 and U.S. Provisional Patent Application Ser. No. 60/544,781 filed Feb. 14, 2004.

Each and all of the foregoing applications are incorporated by reference as if fully set forth herein.

### COPYRIGHT NOTICE

This disclosure is protected under United States and International Copyright Laws. ©2012 Steven M. Cristol. All Rights Reserved. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

Embodiments of the invention relate to enhancing business performance, market impact, and brand equity by optimizing product development portfolios and technology portfolios and better integrating and aligning product strategy and technology strategy with brand strategy.

The preferred embodiment of the particular embodiments addresses this problem and many related ones.

### BRIEF DESCRIPTION OF THE DRAWINGS

Preferred and alternative examples of the present invention are described in detail below with reference to the following drawings:

FIG. 1 is a diagram of the sustainability assessment of the preferred embodiment.

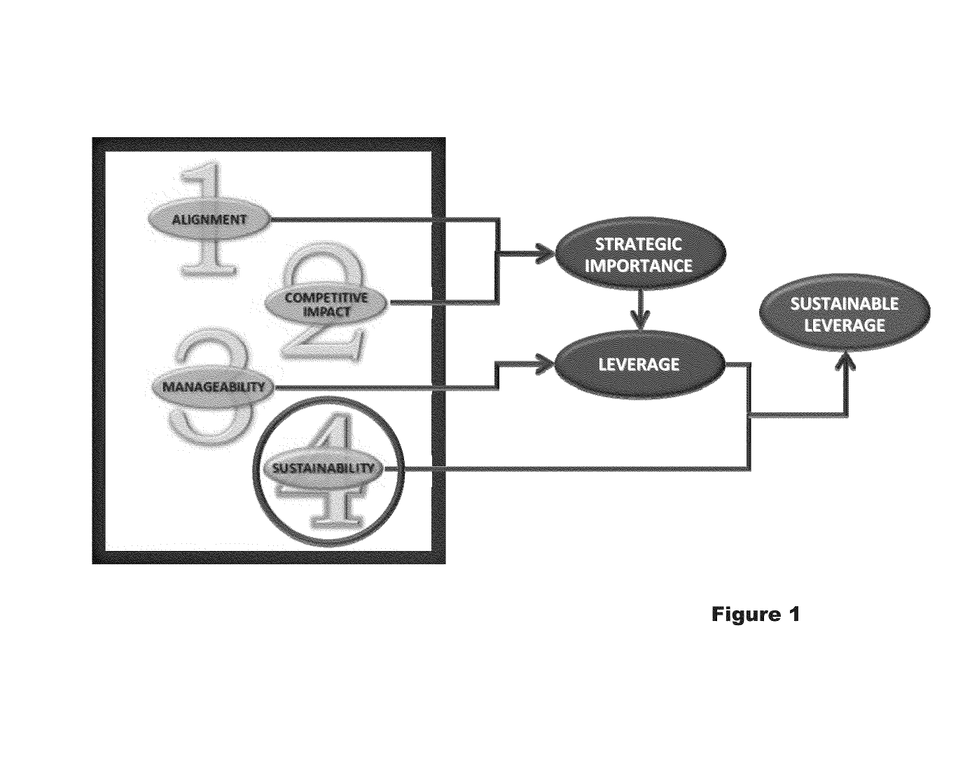

FIG. 2 illustrates the sustainability assessment scoring of the preferred embodiment.

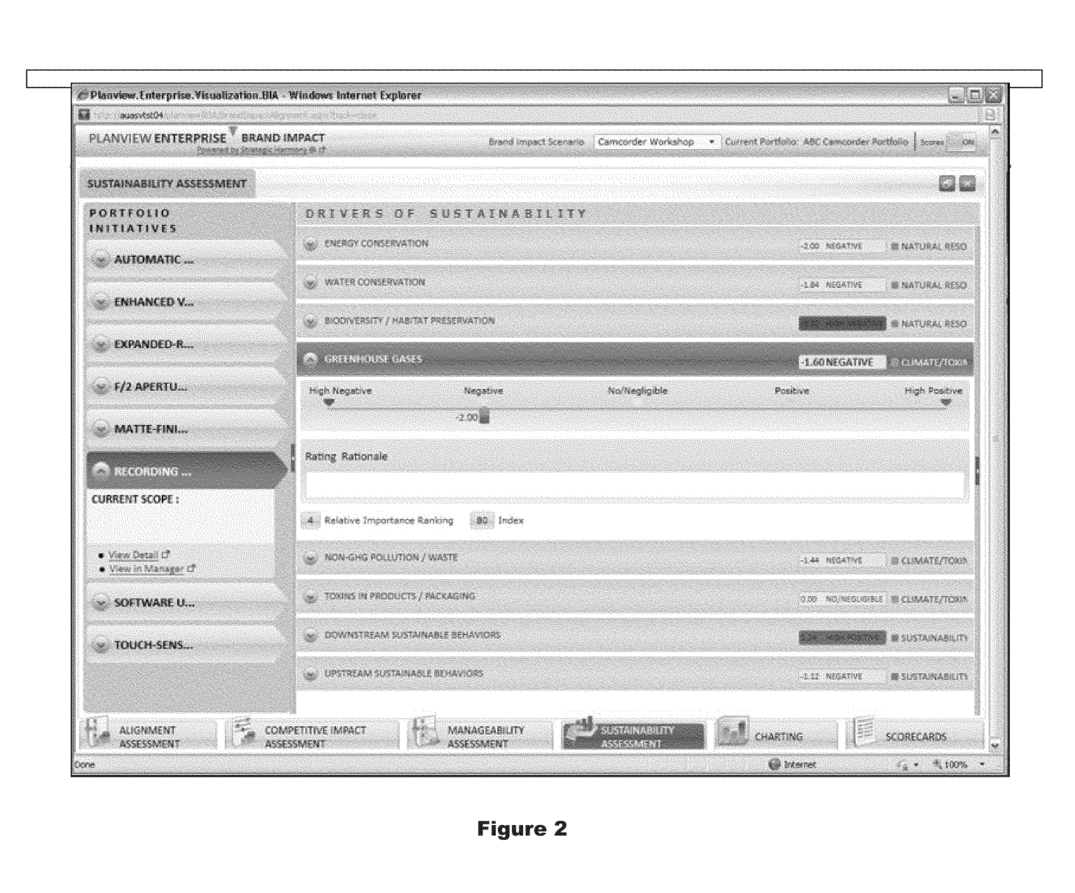

FIG. 3 illustrates the sustainability scorecard and sustainable leverage quadrant map of the preferred embodiment.

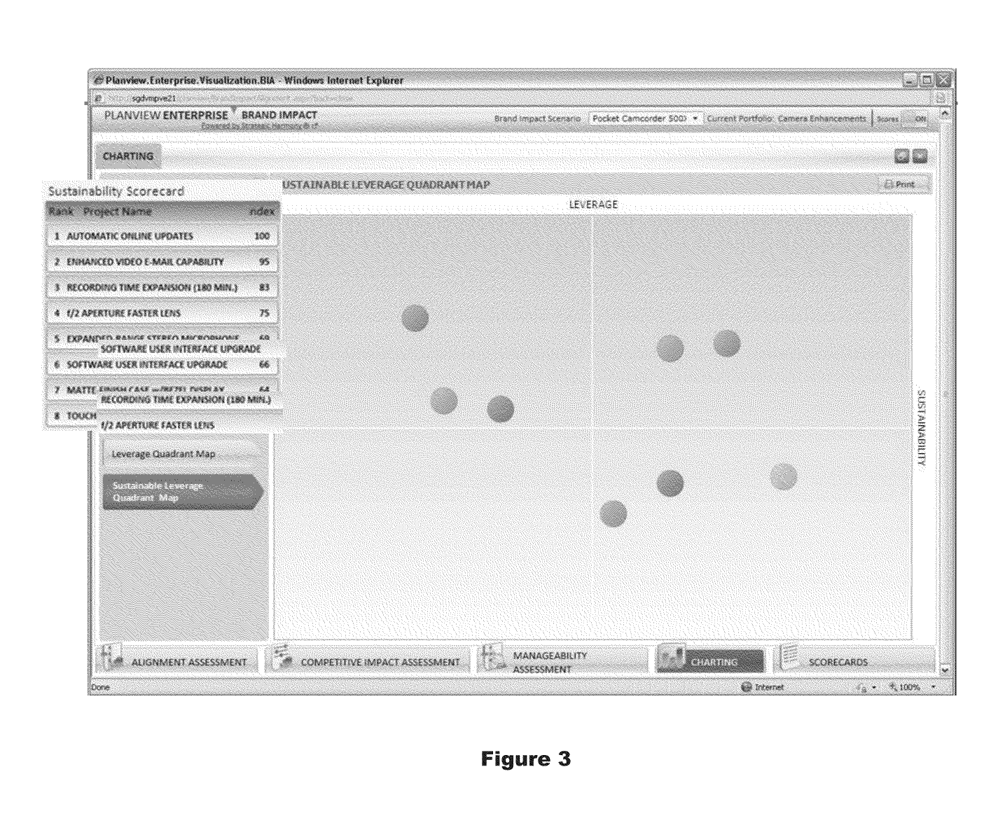

FIG. 4 illustrates how each portfolio project aligns with drivers of environmental sustainability in the preferred embodiment.

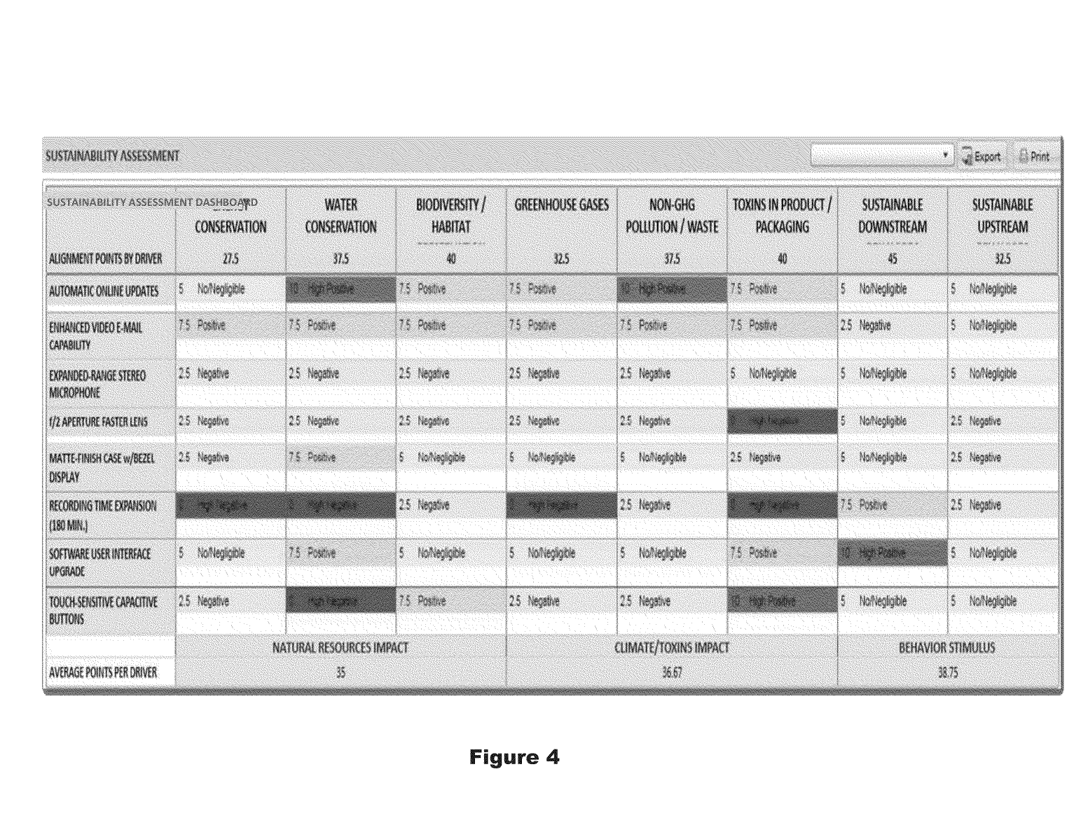

FIG. 5 illustrates the sustainability dashboard of the preferred embodiment.

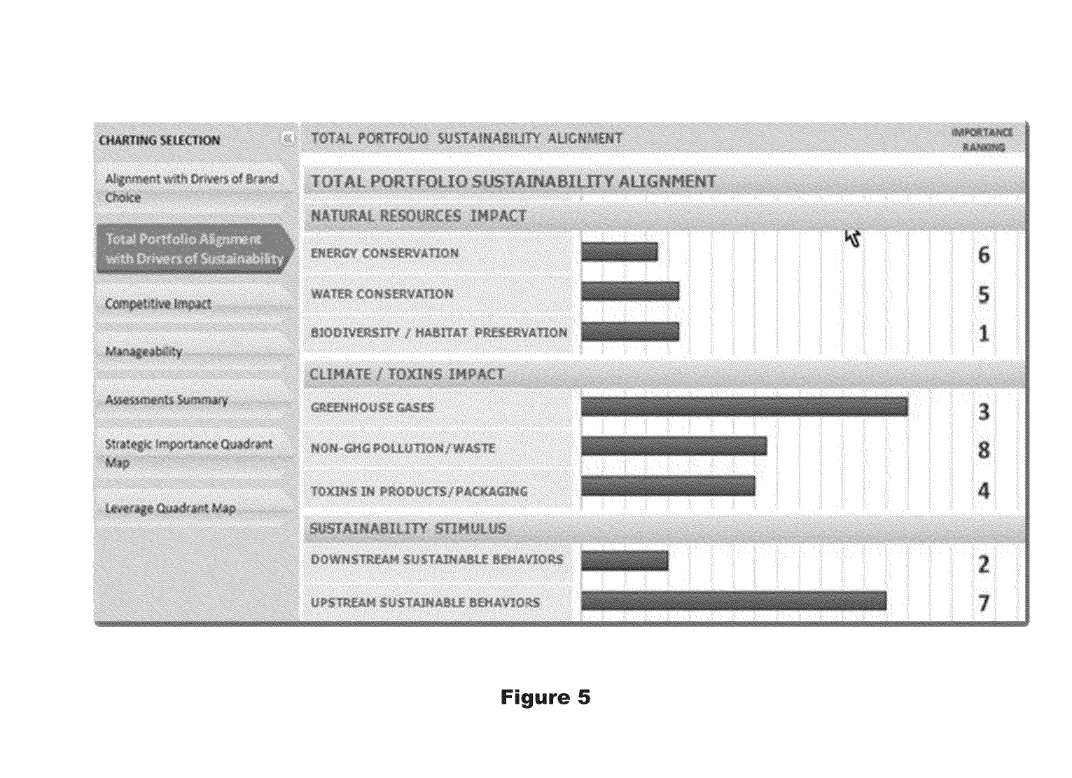

FIG. 6 illustrates the comparison of alignment, competitive impact and sustainability in the preferred embodiment.

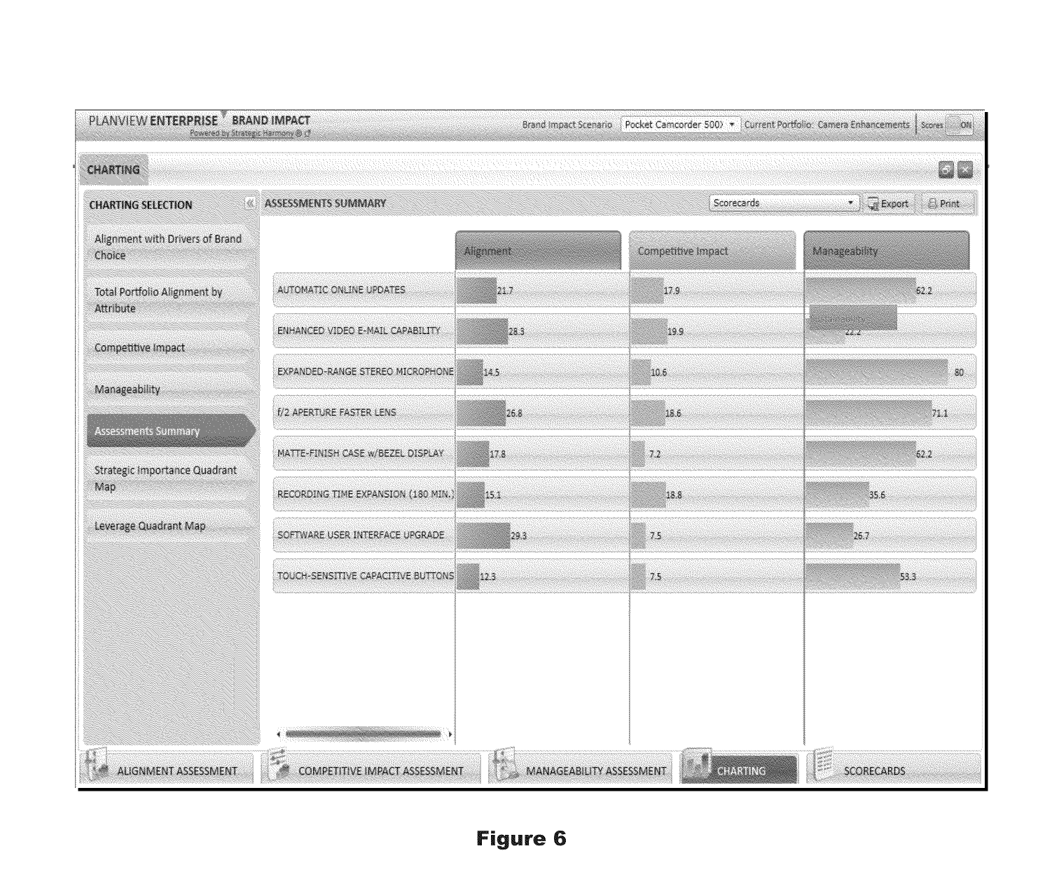

FIG. 7 illustrates the brand impact scorecards of the preferred embodiment.

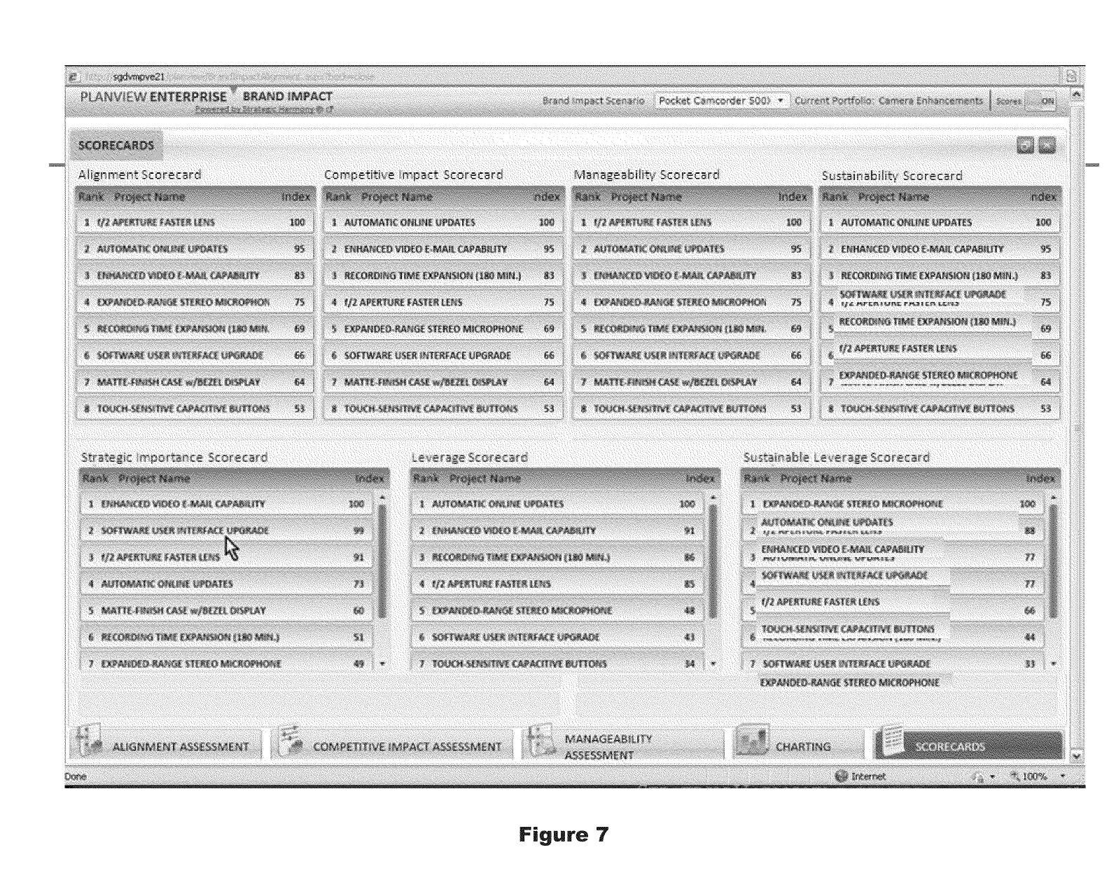

FIG. 8 illustrates the leverage maps of the preferred embodiment.

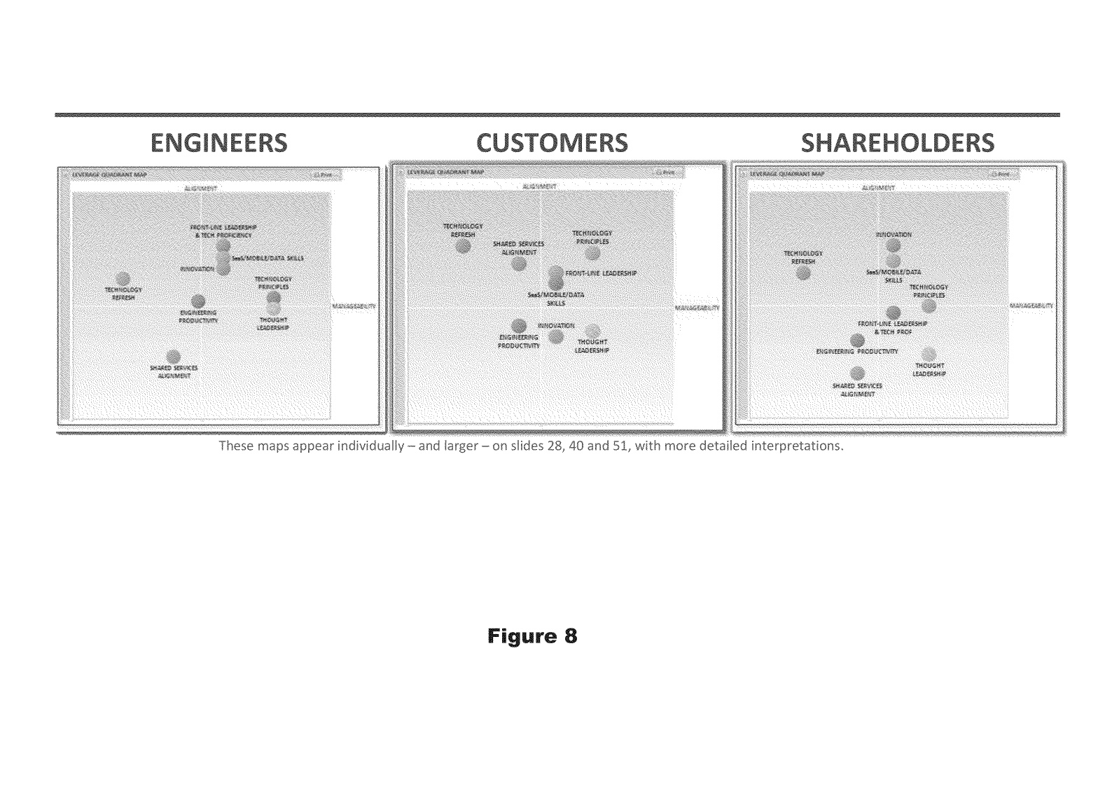

FIG. 9 illustrates the alignment score comparisons of the preferred embodiment.

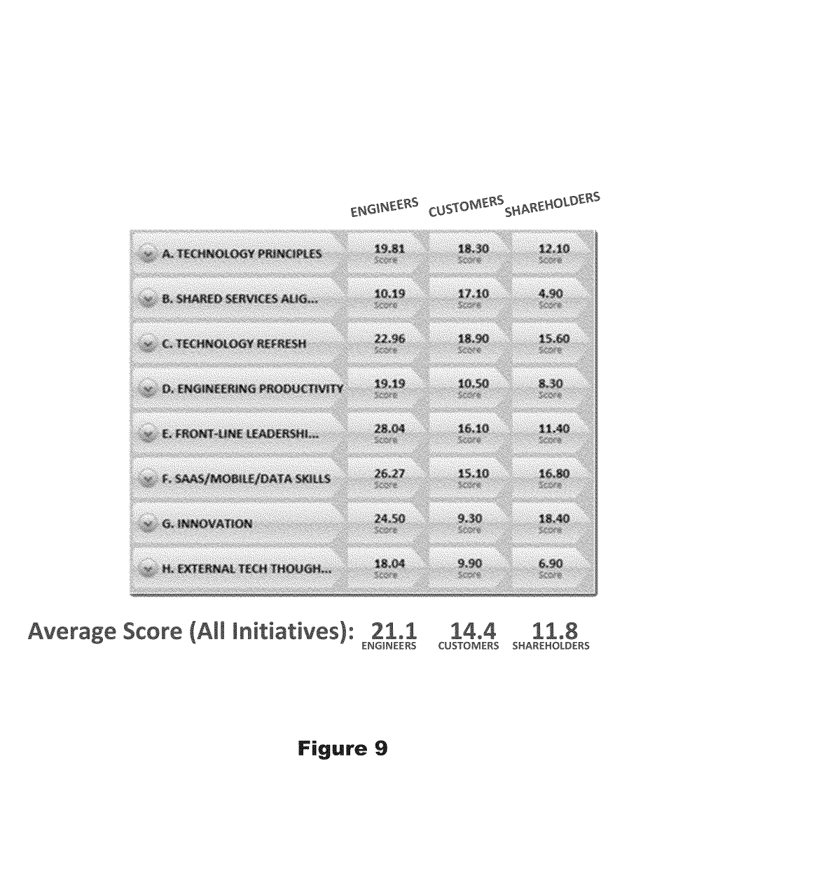

FIG. 10 illustrates the comparison of alignment and manageability scores in the preferred embodiment.

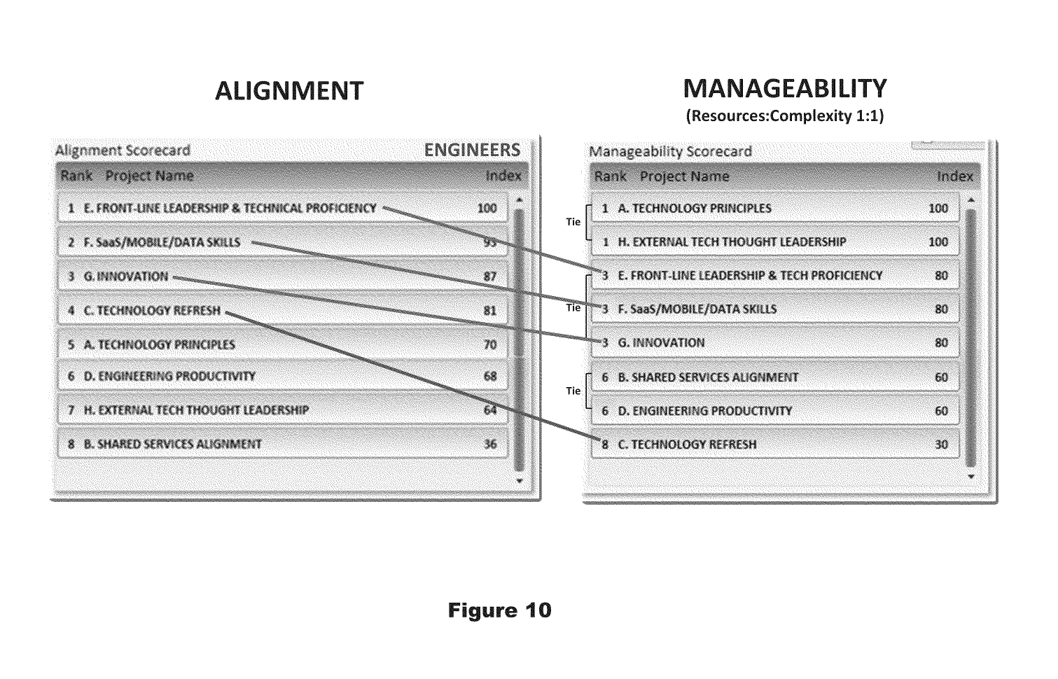

FIG. 11 illustrates the leverage quadrant map for engineers of the preferred embodiment.

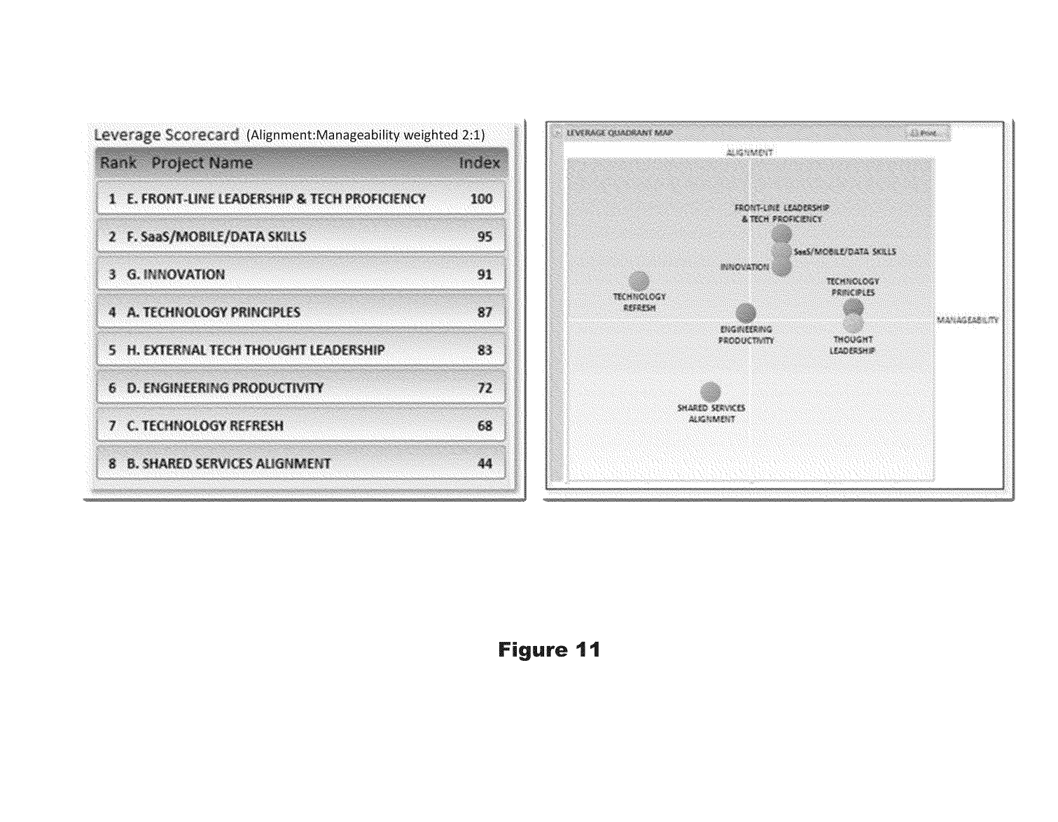

FIG. 12 illustrates the ratings recap for engineers in the preferred embodiment.

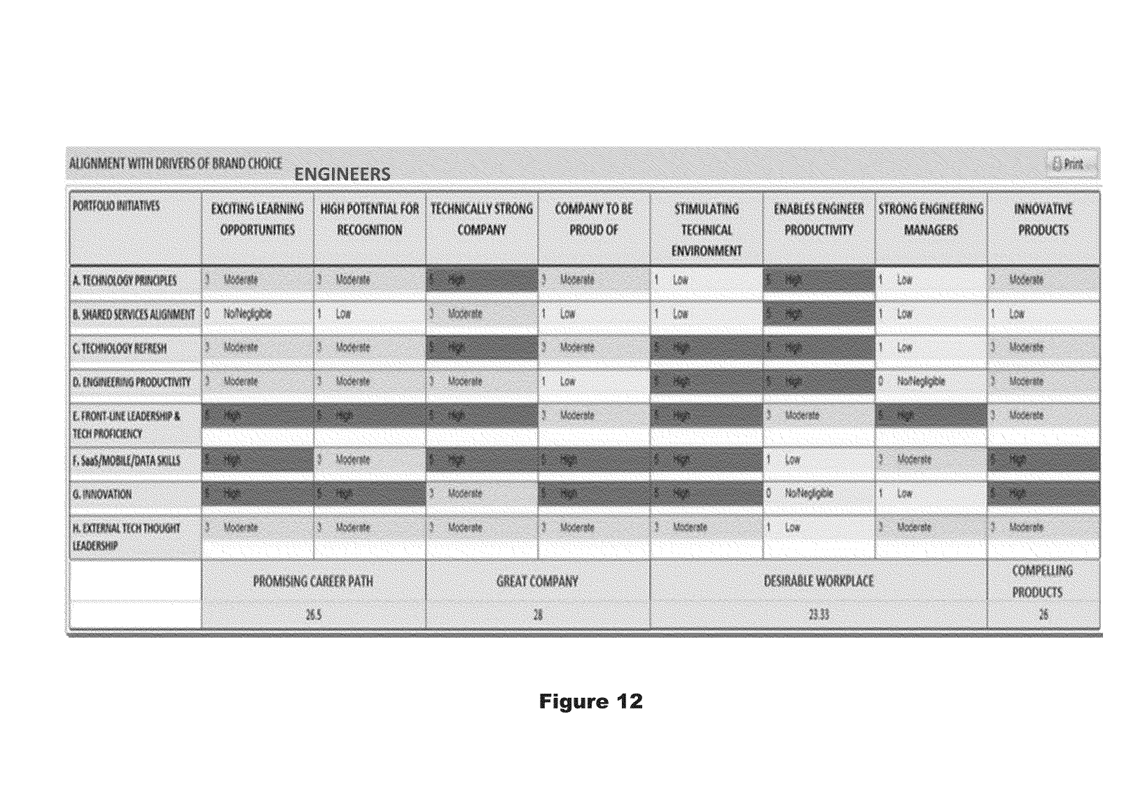

FIG. 13 further illustrates the comparison of alignment and manageability scores in the preferred embodiment.

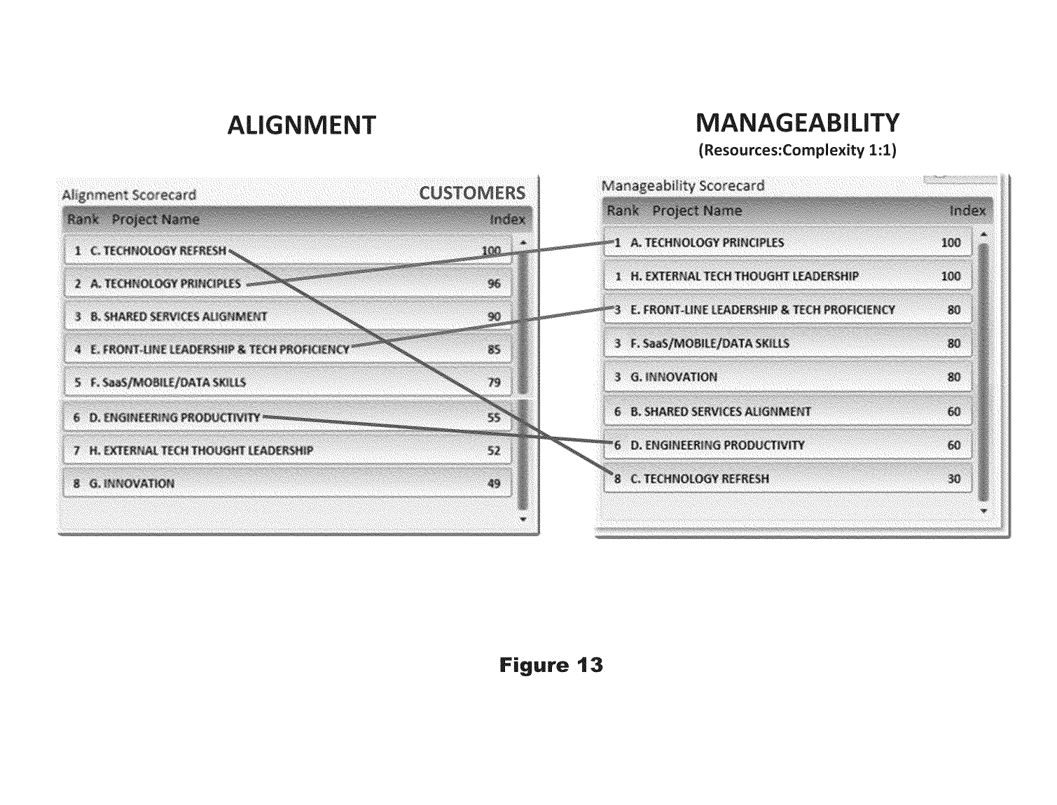

FIG. 14 illustrates the leverage scorecards of the preferred embodiment.

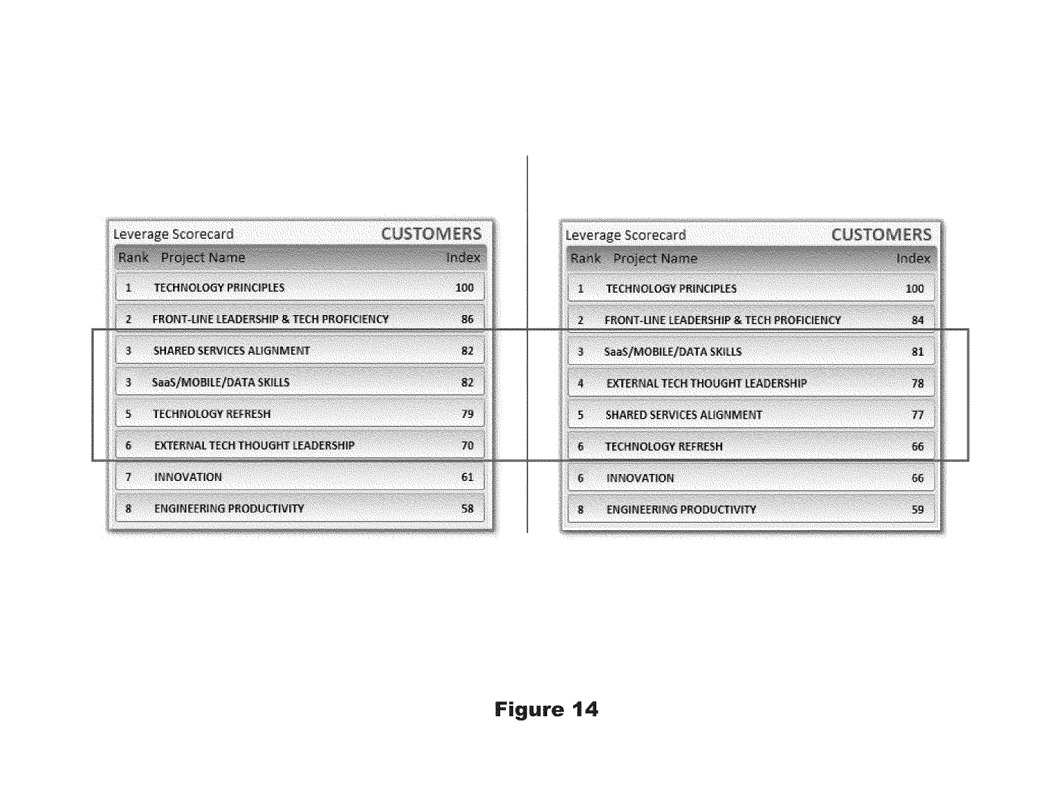

FIG. 15 illustrates the leverage quadrant map for customers of the preferred embodiment.

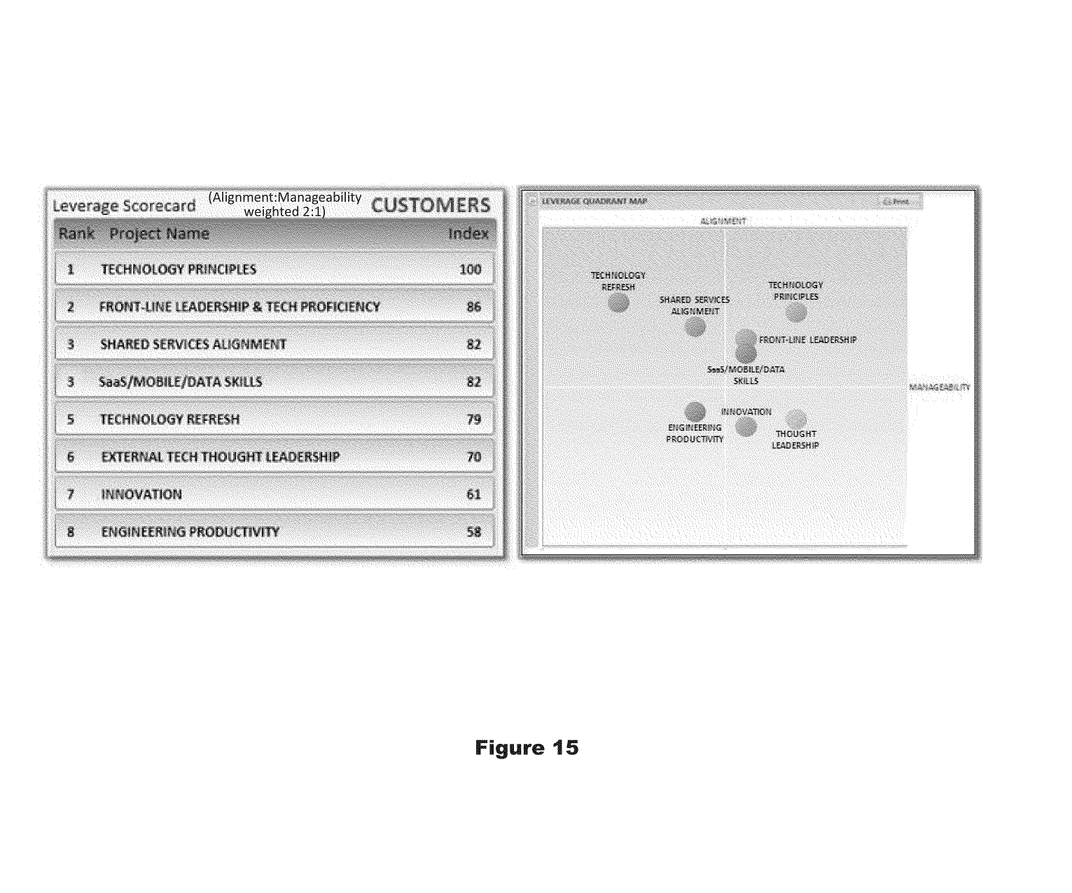

FIG. 16 illustrates the ratings recap for customers in the preferred embodiment.

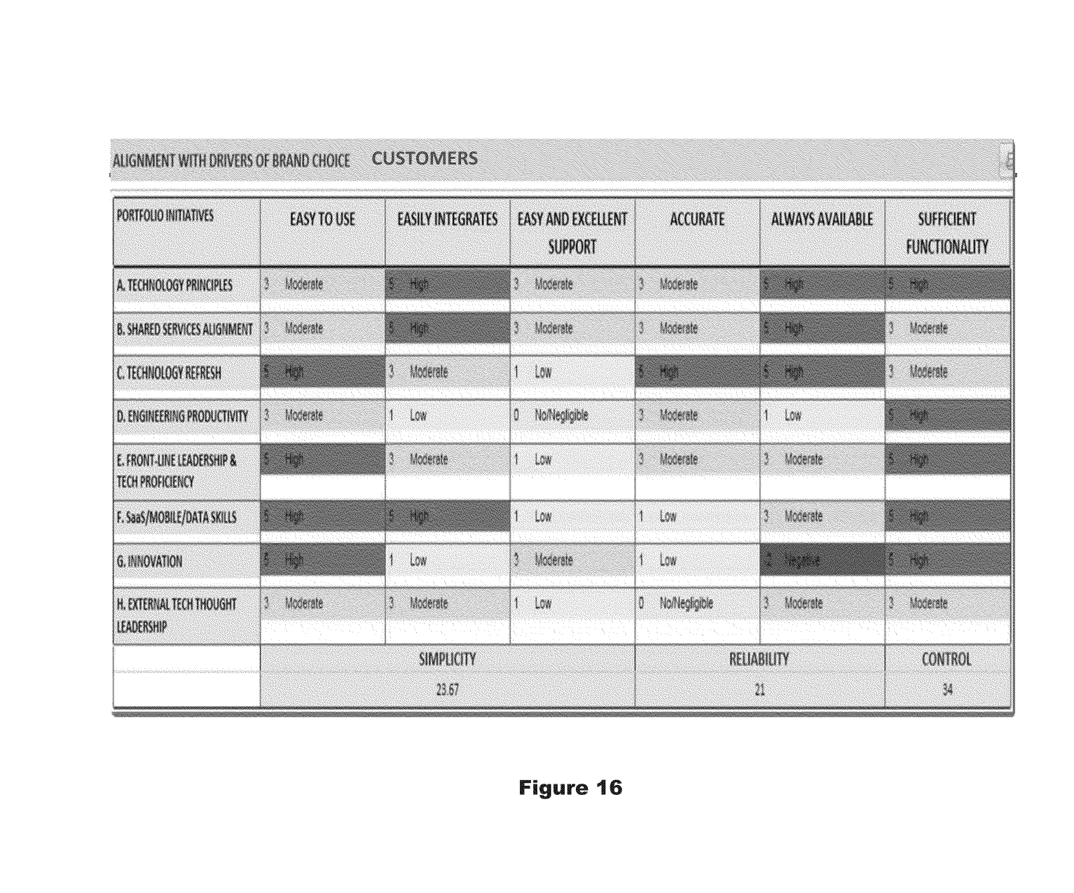

FIG. 17 further illustrates the comparison of alignment and manageability scores of the preferred embodiment.

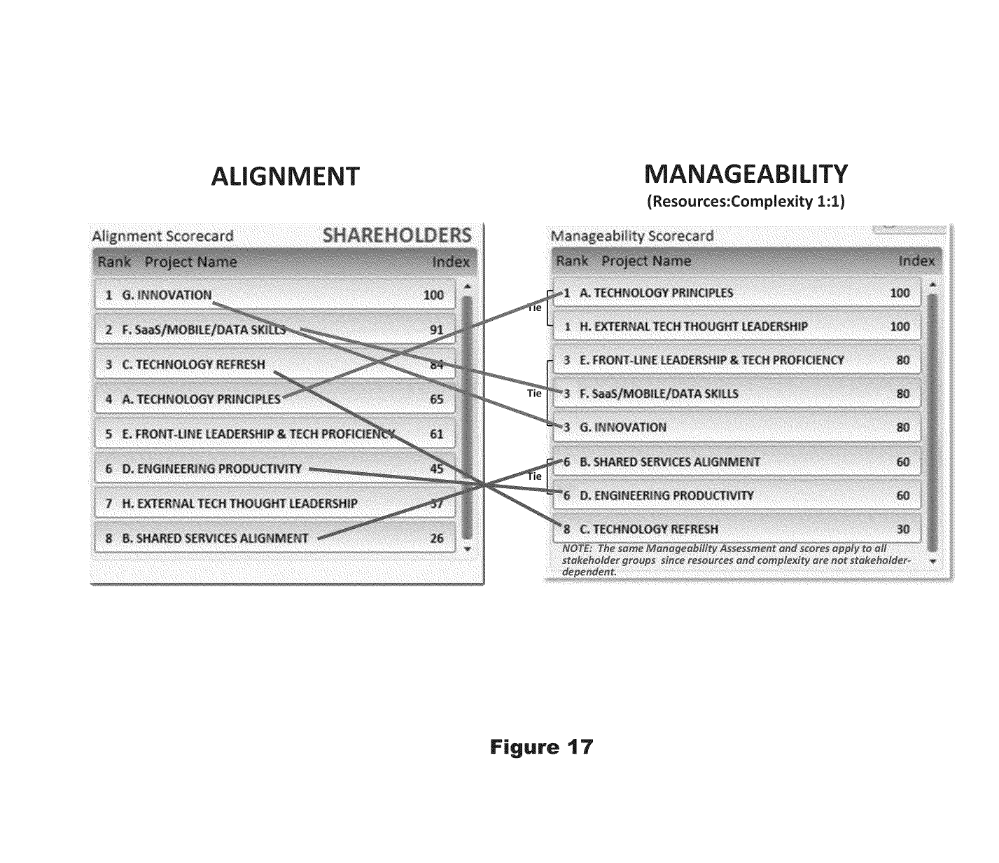

### BACKGROUND OF THE INVENTION

At any point in time, companies that develop products and services typically have too many product development and technology projects competing for too few resources. Strong business performance therefore requires sound decisions in prioritizing these projects—knowing which ones to accelerate or decelerate, and which ones to make narrower in scope or to suspend or kill. This in turn requires the best possible visibility into the relative strengths and weaknesses of each project in terms of its likely impact on the company's brand(s) and its ability to create value for the company's customers and shareholders.

Strategic Harmony® is a system and decision model for providing such visibility and related decision support, and is encompassed in the patent and prior applications referenced above in “Related Applications.” Two trends provide opportunities to further improve the utility of this system and decision model. The first trend is that it is becoming more critical each year to include sustainability (particularly environmental impact) in analyzing product and technology portfolio strengths and weaknesses, as a company's brand value and brand strength is increasingly impacted by public perceptions of how sustainable the company's business practices really are. Also impacted is the company's ability to attract and retain employees, who increasingly prefer to work for environmentally sustainable companies, and to attract the growing number of investors who prefer to invest in socially responsible companies. The second trend, somewhat unrelated but occurring in parallel, is that the discipline of product portfolio management is being applied more broadly and deeply across the enterprise in an increasing number of large companies.

This invention expands the Strategic Harmony® system and model by adding and fully integrating the ability to: (1) incorporate a Sustainability Assessment into the model that can be conducted in parallel with the model's other three assessments (Alignment, Competitive Impact, Manageability) and that integrates sustainability analytics with analytics produced by those other three assessments (unlike existing sustainability assessment frameworks that are standalone evaluations and/or not integrated with other core product strategy and brand strategy metrics, and therefore result in delayed decisions regarding sustainability that cause more expensive and complex course corrections later in the product development process); (2) incorporate the ability to apply product development portfolio management disciplines more broadly to include not only CIO (Chief Information Officer) project portfolios, but also technology/CTO (Chief Technology Officer) project portfolios for evaluation of brand impact across multiple stakeholder groups, including but not limited to customers, investors, and engineers/employees.

### DETAILED DESCRIPTION OF THE PREFERRED EMBODIMENT

In one embodiment, described more fully below and further discussed in Appendix A attached hereto, the contents of which are hereby incorporated by reference in its entirety, there are four factors: Alignment, Competitive Impact, Manageability, and Sustainability. These are variables on which product development and/or technology initiatives, and the collective portfolios that comprise them, are evaluated using the Strategic Harmony® system and model. By applying these variables to portfolio evaluation, and integrating all four variables to produce higher-order metrics, the product development/technology projects that a company actually pursues and delivers will be better aligned and integrated with the company's brand strategy (what the company promises customers and what its brand tries to stand for in customers' minds). These projects will be more likely to satisfy customers, disadvantage competitors, and more efficiently convert development investments to market impact and value creation.

In this embodiment a portfolio of projects that may be product development projects (new products or platforms or services, or new features or functionality of existing products, or features of new services), or IT (Information Technology) projects, or non-IT technology initiatives such as those found in the project portfolio of a Chief Technology Officer, is evaluated on (1) alignment with drivers of brand choice (i.e., relative degree of positive impact on customer experience), (2) competitive impact (i.e., relative degree of negative impact on competitors), (3) manageability (i.e., relative financial and human resource requirements to develop and deliver the project, and relative risks and complexity of developing and delivering) and (4) sustainability (chiefly the negative or positive relative environmental impacts of developing and delivering each product or technology, on through and including product use and re-use/recycling/end-of-life. The Sustainability Assessment is based on a relative scoring scheme that, using a 5-point scale that can be customized for more granular approaches, rates each project on a defined set of “drivers of sustainability.” Selection of these drivers as evaluation criteria may also be customized and delineated at any level of detail, but in the default setting of this model these drivers comprise eight factors within the realms of natural resources impacts, climate and toxins impacts, and types of behavior that the product or technology or service will likely stimulate.

These eight default drivers of environmental sustainability are: (1) Energy Conservation (comprising electricity, oil and natural gas consumption), (2) Water Conservation, (3) Biodiversity/Habitat Preservation (comprising impacts on forests, soil, marine habitat, wetlands, and animal species), (4) Greenhouse Gases (comprising CO₂ emissions and destructive non-carbon emissions such as nitrous oxide, methane, CFCs),
(5) Non-Greenhouse Gas Pollution and Waste (comprising volumes of municipal solid waste, toxic solid waste, landfill waste, toxic effluents, risk of toxic spills, and packaging waste), (6) Products/Packaging Toxins (if a product portfolio, toxins in the products and packaging themselves), (7) Downstream Sustainable Behaviors (degree to which products/technologies stimulate environmentally sustainable customer behavior and distribution channel behavior, which may include distribution transportation/shipping, retailer/reseller behavior, and disposal/recycling/re-use outcomes), (8) Upstream Sustainable Behaviors (degree to which products/technologies stimulate environmentally sustainable behaviors in the company's supply chain and among its third-party partners in bringing a product/technology to fruition). Collectively, ratings on these eight factors produce scores in the model for how each portfolio performs on three higher-level environmental themes: (1) Natural Resources Impacts, (2) Climate/Toxins Impacts and (3) Sustainability Stimulus.

Ratings on the eight sustainability drivers (or, an indeterminate number if customized by a company using the model), are entered into commercially available enterprise software which, under license, has embedded Strategic Harmony® intellectual property that enables automated production of portfolio analytics. Specifically regarding Sustainability, those analytics include Sustainability Dashboards (“Alignment with Drivers of Sustainability” and “Total Portfolio Sustainability”) and a Sustainability Scorecard that integrates with other Strategic Harmony® metrics (including the Alignment Scorecard, Competitive Impact Scorecard, and Manageability Scorecard to produce higher-order analytics including a Sustainable Leverage Scorecard and Sustainable Leverage Quadrant map that fully integrate results of analyses on all four factors in this embodiment. Any set of drivers of sustainability can be used for these analyses within the Strategic Harmony® framework; the ones described simply represent a carefully selected, reasonable best-practices combination of environmental impact assessment variables and are stored in the software application as a default starting point for these evaluations.
In alternate embodiments:

In Competitive Impact Assessment: Potential position changes in competitive standing (baseline) are graphically indicated on the Competitive Impact Dashboard by the following legend of possible outcomes:

Alignment Throughput to Competitive Impact: The degree to which Alignment with Drivers of Brand Choice converts to Competitive Impact is calculated by dividing each initiative's Competitive Impact Score by its Alignment Score and expressing the resulting quotient as a percentage, which is then graphically superimposed on the Assessments Comparison Dashboard (aka “Assessments Recap” in the patent application).

Dual Contexts for Total Portfolio Alignment Dashboard: Two interpretive contexts are graphically superimposed on the bar graph known as “Total Portfolio Alignment by Attribute.” The first context is Attribute Importance, depicting either relative importance index or ranking tier for each attribute (driver of brand choice), and the second is Current Competitive Standing (Baseline). Each provides context for whether the aggregate delivery of benefits by the total assessed portfolio may be in surplus or deficit relative to the strategically appropriate level of benefit delivery.

Total Portfolio Alignment with Drivers of Sustainability: Additional bar graph (parallel format to “Total Portfolio Alignment by Attribute”) sums all initiatives' scores on each driver of sustainability and represents the relative aggregate impact on each sustainability driver. The context of relative importance of each driver is superimposed to enable assessment of potential surplus or deficit on impact on each driver.

Sustainability Scoring Scale: Sustainability scores are based on a 5-point scale of impacts comprising High Positive, Low Positive, No/Negligible Impact, Low Negative, High Negative, with default values of, respectively, +4.00, +2.00, 0, −2.00, and −4.00. As with all other Strategic Harmony® scoring scales, defaults are customizable per use case.

Sustainable Leverage: Scores on the Sustainable Leverage Scorecard (which indicates how environmentally sustainably the relative market leverage of each initiative can potentially be achieved) are calculated by weighting the Leverage Scorecard and the Sustainability Scorecard relative to each other (allocating a portion of 100 total points to each) and then combining the scores based on that weighting.

In Manageability Assessment: The default factors of Resource Requirements and Complexity/Risk are customizable per use case, allowing for delineation of an expanded number of Manageability components such as more specifically defined risks and complexities.

Definition of “Portfolio”: Portfolios of initiatives assessed with the Strategic Harmony® methodology may include not only “product” and “IT” (information technology) portfolios as referenced in the patent application, but any portfolio of initiatives competing for resources and that may ultimately impact a company's customers and/or competitors, including but not limited to technology/CTO (chief technology officer) initiatives portfolios, service initiatives portfolios, packaging initiatives portfolios, retail/merchandising/store design initiatives portfolios, corporate sponsorship initiatives portfolios, and hybrid portfolios.

All the foregoing analyses of Alignment, Competitive Impact, Manageability, and Sustainability are applicable not only to evaluation of portfolio impact on a company's customers and competitors, but also on other important stakeholder groups such as investors/shareholders and employees (including engineers and R&D personnel who may design and develop new products, platforms, and/or other technology initiatives).

While the preferred embodiment of the invention has been described above and illustrated in the appended visual representations, many modifications may be made without departing from the spirit and scope of the invention. Accordingly, the scope of the invention is not limited by the disclosure of the preferred embodiment.

The embodiments of the invention in which an exclusive property or privilege is claimed are defined as follows:

1. A business system and decision model to build brand equity or improve business performance through more effective product/technology portfolio management and better alignment of product and technology strategy with brand strategy, comprising: assessing a portfolio on the basis of one or more of the following four factors:
Alignment with drivers of brand choice (ideal customer experience);
Competitive Impact (advantaging the company, disadvantaging its competitors);
Manageability (financial and human resource requirements, complexity and risk;
Sustainability (relative environmental impacts), producing metrics that inform decisions regarding prioritizing or reprioritizing initiatives in such portfolios, and producing analysis that informs decisions regarding resource allocation based on the relative value of each portfolio initiative/project assessed.

2. A computer-readable medium having instructions stored thereon that, when executed by a computer, enable the computer to perform the assessments in claim 1, wherein assessment includes evaluating each portfolio on the four factors of:
Alignment with drivers of brand choice (ideal customer experience);
Competitive Impact (advantaging the company, disadvantaging its competitors);
Manageability (financial and human resource requirements, complexity and risk;
Sustainability (relative environmental impacts).

3. A computer-readable medium having instructions stored thereon that, when executed by a computer, enable the computer to perform the assessments in claim 2 and to aggregate them, weight them, and integrate them to produce metrics that display one or more of the following:
Sustainable Leverage Scorecard;
Alignment with Drivers of Sustainability Dashboard;
Total Portfolio Sustainability Dashboard; and a
Sustainable Leverage Quadrant Map.

4. The system and model of claim 1, wherein assessment includes evaluating each portfolio initiative in terms of its alignment with ideal attributes from the perspective of one or more of the following:
customers (ideal customer experience), investors/shareholders (ideal investor experience), and employees/engineers (ideal employee/engineer experience).
